(19) United States
(12) Patent Application Publication
(10) Pub. No.: US 2011/0077013 A1
(43) Pub. Date: Mar. 31, 2011

(54) METHOD OF COMMUNICATING AND ESTABLISHING RELAY CHANNEL BETWEEN BASE STATION AND NON-LINE-OF-SIGHT CHANNEL TERMINAL IN NEXT GENERATION CELLULAR COMMUNICATION SYSTEM

(75) Inventors: Dong Ho Cho, Daejeon (KR); Sung Yeop Pyun, Daejeon (KR); Chi Sung Bae, Daejeon (KR); Soo Yong Jeon, Jeollabuk-do (KR); Woong Sup Lee, Daejeon (KR); Woo Chan Kim, Daejeon (KR)

(73) Assignee: KOREA ADVANCED INSTITUTE OF SCIENCE AND TECHNOLOGY, Daejeon (KR)

(21) Appl. No.: 12/995,742

(22) PCT Filed: Feb. 24, 2009
(86) PCT No.: PCT/KR2009/000869

§ 371 Date: Dec. 2, 2010

(30) Foreign Application Priority Data
Jun. 2, 2008 (KR) 10-2008-0051431

(51) Int. Cl. H04W 40/00

(52) U.S. Cl. 455/445

(57) ABSTRACT

Disclosed herein are a method of communicating and establishing a relay channel between a base station and a non-line-of-sight channel terminal in a next generation cellular communication system. The method of communicating between a base station and a non-line-of-sight channel terminal includes a first step of the base station receiving channel state information from the non-line-of-sight channel terminal; a second step of the base station collecting channel state information between the non-line-of-sight channel terminal and adjacent terminals; a third step of, if there is a relay channel terminal that belongs to the adjacent terminals and that can ensure line-of-sight channels to the base station and the non-line-of-sight channel terminal, the base station and the non-line-of-sight channel terminal performing high frequency cellular communication via the relay channel terminal; and a fourth step of, otherwise, the base station and the non-line-of-sight channel terminal performing low frequency cellular communication.

### TECHNICAL FIELD

The present invention relates generally to a method of communicating between a base station and a terminal in a next generation cellular communication system using the tens of GHz band, and, more particularly, to a method of communicating and establishing a relay channel between a base station and a non-line-of-sight channel terminal.

### BACKGROUND ART

Currently, cellular communication systems provide voice or data services to users in relatively wide regions by using the 2 GHz or narrower frequency band. Since the current cellular communication systems provide low speed services at a maximum of several Mbps, there is no serious problem with the provision of the services, even though the bandwidth is narrow. Furthermore, since the frequency band less than 2 GHz provides relatively desirable propagation characteristics, communication is enabled, even though a line-of-sight channel may not be ensured between a base station and a terminal.

Meanwhile, since the Federal Communications Commission (FCC) assigned a frequency band of a total of 7 GHz ranging from 57 GHz to 64 GHz to an unlicensed band in 2001, research and system development related to this frequency band have been actively performed. Systems using the 60 GHz high frequency band for communication include a very short distance communication system, such as a Wireless Personal Area Network (WPAN), and a wireless trunk system configured to replace a conventional wired trunk between buildings.

The communication systems using high frequency carrier have an advantage of ensuring a wide bandwidth and, therefore, of providing high-speed data communication of several Gbps, but have a disadvantage of having undesirable propagation characteristics because the high frequency carrier cannot pass through obstacles well due to its strong rectilinear propagation property and because most of the energy of the high frequency carrier is absorbed by oxygen.

Accordingly, since a high frequency band communication system using an omnidirectional antenna cannot perform communication in an area wider than a several tens of meter area that can ensure a line-of-sight channel, it can be used only for very short distance communication.

Meanwhile, since a high frequency band communication system using high-gain directional antenna, such as a parabolic antenna, has advantages of having a long propagation distance, providing desirable security due to a narrow antenna beam width, and facilitating the frequency reuse due to the mitigation of interference between frequencies, this system is being used as the wireless trunk system. However, this parabolic antenna can be used only for point-to-point communication, and cannot be used for point-to-multipoint communication. Accordingly, in order to enable point-to-multipoint communication while ensuring the maximal gain of the antenna, it must be possible to change the directionality of an antenna using an array antenna.

It can be said that in current communication services, almost all of low frequency bands having desirable propagation characteristics have been used. Accordingly, the FCC assigned a frequency band of a total of 7 GHz ranging from 57 GHz to 64 GHz to an unlicensed band, and the International Telecommunication Union (ITU) considers frequency bands up to a several tens of GHz band as candidate frequency bands for a cellular communication system.

Since the existing cellular communication systems using low frequency bands provide services at a low speed of a maximum of several Mbps, there is no problem, even though the bandwidth is narrow. However, in the future, in response to users' demands, it will be necessary to provide a service at a very high speed in a range of several hundred Mbps to several Gbps using a high frequency band.

The communication systems using high frequency bands, which have been developed up to now, are limited to WPAN systems having very narrow service areas or wireless trunk systems using high gain parabolic antennas while taking into account propagation characteristics.

If an array antenna is used in communication system using high frequency bands, extension to a general communication system such as a cellular communication system can be made, and high gain and a variety of directionality can be ensured. However, due to the propagation characteristics of a high frequency band and the capacity of a backbone network connecting base stations, the service radius of a base station is reduced and the portion of a shadow area is increased, so that many non-line-of-sight channels occur between the base station and terminals. Furthermore, when a terminal moves, the channel environment of the terminal is frequently changed from a line-of-sight channel environment to a non-line-of-sight channel environment or from a non-line-of-sight channel environment to a line-of-sight channel environment. Since the high frequency band has undesirable propagation characteristics, the intensity of signals are low in the case where a line-of-sight channel is not ensured, so that there is a problem in that a communication service cannot be provided to a non-line-of-sight channel terminal.

In order to solve this problem, the present applicant filed a patent application entitled “Communication Method using Group Collaboration and Relay in Next Generation Cellular Communication Systems” with the Korean Intellectual Property Office (Korean Patent Application No. 2007-100764).

Referring to FIG. 1, the invention disclosed in Korean Patent No. 2007-100764 will be described below. FIG. 1 is a diagram showing a method of constructing the communication link of Korean Patent Application No. 2007-100764 in a next generation cellular communication system. A base station exchanges data with terminals ensuring line-of-sight channels by directly forming beams toward them using an array antenna, and communicates with terminals incapable of ensuring line-of-sight channels using the group collaboration and relay of adjacent terminals capable of ensuring line-of-sight channels.

In the following specification and claims, a terminal ensuring a line-of-sight channel to a base station is referred to as a line-of-sight channel terminal, and a terminal not ensuring a line-of-sight channel to a base station is referred to as a non-line-of-sight channel terminal.

In the case where a line-of-sight channel terminal is blocked by an obstacle such as a building while the terminal is moving and a channel environment changes to a non-line-of-sight channel environment in which the terminal cannot communicate directly with a base station as shown in FIG. 1, the base station and the non-line-of-sight channel terminal establish a communication link with the assistance of adjacent line-of-sight channel terminals and exchange data with each other. For this purpose, a relay-cooperation relay group 11, that is, a set of terminals for assisting the transmission of data in an intermediate area, is defined, and a transmission/reception terminal group 12 for transmitting/receiving signals relayed by the relay-cooperation relay group 11 is defined.

The relay-cooperation relay group 11 must include at least one terminal that ensures a line-of-sight channel to the base station and can transmit and receive signals in a high frequency band directly to and from the base station. That is, the relay-cooperation relay group 11 includes a relay-cooperation relay terminal 11a capable of transmitting and receiving signals directly to and from the base station and relay-cooperation assistance terminals 11b. The relay-cooperation relay terminal 11a must satisfy the conditions that it ensures a line-of-sight channel to the base station and does not communicate with the base station, and each of the relay-cooperation assistance terminals 11b must satisfy the conditions that it must be a terminal that is adjacent to the relay-cooperation assistance terminals 11a and that can ensure a line-of-sight channel to the relay-cooperation relay terminal 11a and it does not communicate with the base station.

Meanwhile, the transmission/reception terminal group 12 includes a final transmission/reception terminal 12a and relay transmission/reception assistance terminals 12b. Each of the relay transmission/reception assistance terminals 12b is a terminal that is located adjacent to the final transmission/reception terminal 12a and that can ensure line-of-sight channels with the final transmission/reception terminal 12a and the relay-cooperation relay terminal 11a and relay-cooperation assistance terminals 11b of the relay-cooperation relay group 11.

As shown in FIG. 1, when the base station BS desires to communicate with the non-line-of-sight channel terminal, it constructs the relay-cooperation relay group 11 and the transmission/reception terminal group 12. The base station BS first transmits data to be transmitted to the final transmission/reception terminal 12a to the relay-cooperation relay terminal 11a, and then the relay-cooperation relay terminal 11a shares and distributes the data with and among the relay-cooperation assistance terminals 11b. Thereafter, the relay-cooperation relay terminal 11a and the relay-cooperation assistance terminals 11b transmit the distributed data to the transmission/reception terminal group 12, and the relay transmission/reception assistance terminals 12b of the transmission/reception terminal group 12 transfer the received data to the final transmission/reception terminal 12a.

In contrast, when the final transmission/reception terminal 12a, that is, the non-line-of-sight channel terminal, desires to transmit data to the base station BS, the relay transmission/reception assistance terminals 12b and the relay-cooperation relay group 11 are constructed, and then the final transmission/reception terminal 12a transmits the data to the base station BS through the relay transmission/reception assistance terminals 12b and the relay-cooperation relay group 11.

The above-described method of constructing a communication link, which is disclosed in Korean Patent No. 2007-100764, needs to solve the following technical problems.

First, a base station does not immediately become aware that the channel environment of a terminal changes from a line-of-sight channel environment to a non-line-of-sight channel environment. That is, while a terminal moves, there are many cases where the terminal maintains a line-of-sight channel and then the line-of-sight channel is blocked by an obstacle, such as a building. In this case, the intensity of a received signal of the terminal is rapidly reduced and then communication is stopped, so that the terminal can immediately become aware of the change from the line-of-sight channel to the non-line-of-sight channel. In contrast, the base station cannot rapidly become aware that the channel environment of the corresponding terminal has changed from the line-of-sight channel environment to the non-line-of-sight channel environment. As a result, there arise problems in that the resources of the base station are wasted because the base station assigns resources to the non-line-of-sight channel terminal incapable of communicating and in that a high-speed data communication service cannot be ensured for the terminal the channel environment of which has been changed from the line-of-sight channel environment to the non-line-of-sight channel environment because the base station mistakes the channel environment of the corresponding terminal for a line-of-sight channel environment and then communication is performed.

Furthermore, in order to establish a communication link through group collaboration and relay as disclosed in preceding Korean Patent Application No. 2007-100764, line-of-sight channels must be ensured between the terminals of the relay-cooperation relay group and the terminals of the transmission/reception terminal group. However, since the base station knows only information about the presence of line-of-sight/non-line-of-sight channels between the base station and terminals, it is impossible to determine whether line-of-sight channels can be ensured between the relay-cooperation relay group and the transmission/reception terminal group based on only the information about the presence of line-of-sight/non-line-of-sight channels between the base station and the terminals.

Moreover, there is a problem in that in the case where there is no terminal capable of group collaboration and relay near the non-line-of-sight channel terminal, the base station cannot provide a communication service to the corresponding non-line-of-sight channel terminal.

### DISCLOSURE OF INVENTION

### Technical Problem

Accordingly, the present invention has been made keeping in mind the above problems occurring in the prior art, and a first object of the present invention is to provide a method in which a base station can immediately detect a change in the line-of-sight/non-line-of-sight channel environment of a terminal.

A second object of the present invention is to provide a method capable of, when establishing a communication link between a base station and a non-line-of-sight channel terminal, ensuring line-of-sight channels between the terminals of a relay-cooperation relay group and the terminals of a transmission/reception terminal group.

A third object of the present invention is to provide a method capable of, if there is no terminal capable of group collaboration and relay near a non-line-of-sight channel terminal, establishing a communication link between a base station and the non-line-of-sight channel terminal.

### Technical Solution

In order to accomplish the above objects, the present invention provides a method of communicating between a base station and a non-line-of-sight channel terminal in a next generation cellular communication system, the method including a first step of the base station receiving channel state information from the non-line-of-sight channel terminal; a second step of the base station collecting channel state information between the non-line-of-sight channel terminal and one or more terminals adjacent to the non-line-of-sight channel terminal; a third step of, if there is a relay channel terminal that belongs to the adjacent terminals and that can ensure a line-of-sight channel to the base station and a line-of-sight channel to the non-line-of-sight channel terminal, the base station and the non-line-of-sight channel terminal performing cellular communication in a high frequency band via the relay channel terminal; and a fourth step of, if there is no relay channel terminal that belongs to the adjacent terminals, the base station and the non-line-of-sight channel terminal performing cellular communication in a low frequency band.

Additionally, in order to accomplish the above objects, the present invention provides a method of establishing a relay channel between a base station and a non-line-of-sight channel terminal in a next generation cellular communication system, the method including a first step of the base station receiving channel state information from the non-line-of-sight channel terminal; a second step of the base station collecting channel state information between the non-line-of-sight channel terminal and one or more terminals adjacent to the non-line-of-sight channel terminal; and a third step of, if there is a relay channel terminal that belongs to the adjacent terminals and that can ensure a line-of-sight channel to the base station and a line-of-sight channel to the non-line-of-sight channel terminal, establishing a relay channel, including the relay channel terminal, between the base station and the non-line-of-sight channel terminal.

### ADVANTAGEOUS EFFECTS

The present invention has advantages in that the waste in which a base station assigns resources to a non-line-of-sight channel terminal incapable of direct communication can be reduced because the base station can rapidly become aware of a change in the line-of-sight/non-line-of-sight channel environment between the base station and a terminal using a control channel in a low frequency band, and in that a seamless communication service can be provided to a terminal, the communication environment of which has been changed from a line-of-sight channel environment to a non-line-of-sight channel environment because a relay-cooperation relay group and a transmission/reception terminal group are immediately constructed.

Furthermore, the present invention has an advantage in that line-of-sight channels can be ensured between a relay-cooperation relay group for performing group collaboration and relay between a base station and a non-line-of-sight channel terminal and a transmission/reception terminal group.

Furthermore, the present invention has an advantage in that a seamless communication service can be rapidly provided between a corresponding base station and a non-line-of-sight channel terminal, even though there is no terminal capable of group collaboration and relay between the base station and the non-line-of-sight channel terminal.

### BRIEF DESCRIPTION OF DRAWINGS

The above and other objects, features and advantages of the present invention will be more clearly understood from the following detailed description taken in conjunction with the accompanying drawings, in which:

FIG. 1 is a diagram showing the concept of an invention disclosed in Korean Patent No. 2007-100764;

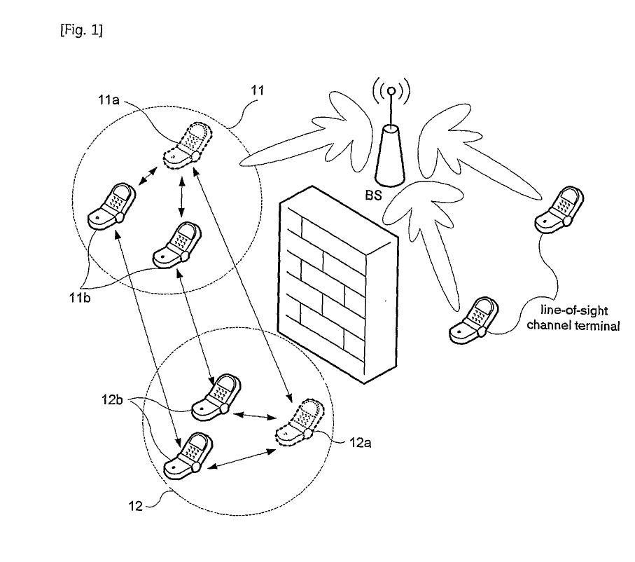

FIG. 2 is a diagram showing the channel environment of a next generation cellular communication system;

FIG. 3 is a flowchart showing a process in which a base station assigns a low frequency band control channel slot to a terminal that enters the cell and a terminal that exits the cell returns the control channel slot to the base station;

FIG. 4 is a diagram illustrating a problem that occurs when a base station establishes a relay channel; and

FIG. 5 is a flowchart showing a method of establishing a relay channel and communicating between a base station and a non-line-of-sight channel terminal according to the present invention.

### MODE FOR THE INVENTION

A method of communicating between a base station and a non-line-of-sight channel terminal in a next generation cellular communication system according to an embodiment of the present invention will be described in detail below with reference to the accompanying drawings.

It is assumed that in the next generation cellular communication system, a base station and terminals use a high frequency band. A high frequency band has an advantage of ensuring a high data transmission rate, but has disadvantages in that transmission distance is short because the rectilinear propagation property thereof is strong and it is difficult to pass through an obstacle and in that a non-line-of-sight channel terminal incapable of ensuring a line-of-sight channel to a base station cannot communicate.

The present invention takes into account the environment in which the next generation cellular communication system using a high frequency band and a current cellular communication system using a low frequency band coexist with each other. That is, the base station and the terminals can access the next generation cellular communication system using a high frequency band and directly communicate with each other, and can access the current cellular communication system using a low frequency band and directly communicate with each other.

Each of the terminals detects its speed and location using a Global Positioning System (GPS) or some other equipment, creates location and speed information, and periodically transmits the location and speed information to the base station. The base station becomes aware of the location and speed (mobility) of the terminal using the location and speed information transmitted by the terminal.

In the present invention, the base station and a line-of-sight channel terminal directly communicate with each other via a high frequency band while taking into account the location and speed information of the terminal.

In contrast, in order to communicate with a non-line-of-sight channel terminal, the base station constructs a relay-cooperation relay group, including terminals capable of group collaboration and relay, and a transmission/reception terminal group, and communicates with the non-line-of-sight channel terminal through the relay-cooperation relay group and the transmission/reception terminal group. Here, terminals capable of group collaboration and relay refer to terminals that ensure line-of-sight channels to the base station, ensure line-of-sight channels to the non-line-of-sight channel terminal, and do not communicate directly with the base station. In the present specification and the following claims, a communication channel between the base station and the non-line-of-sight channel terminal through the relay-cooperation relay group and a transmission/reception terminal group is referred to as a relay channel. A terminal that performs group collaboration and relay in a relay channel is referred to as a relay channel terminal. That is, the base station establishes a relay channel to communicate with the non-line-of-sight channel terminal, and the base station and the non-line-of-sight channel terminal communicate with each other via the relay channel over the high frequency band. Meanwhile, when the base station cannot establish a relay channel for communicating with the non-line-of-sight channel terminal, the base station and the non-line-of-sight channel terminal directly communicate with each other via the cellular communication system using a low frequency band.

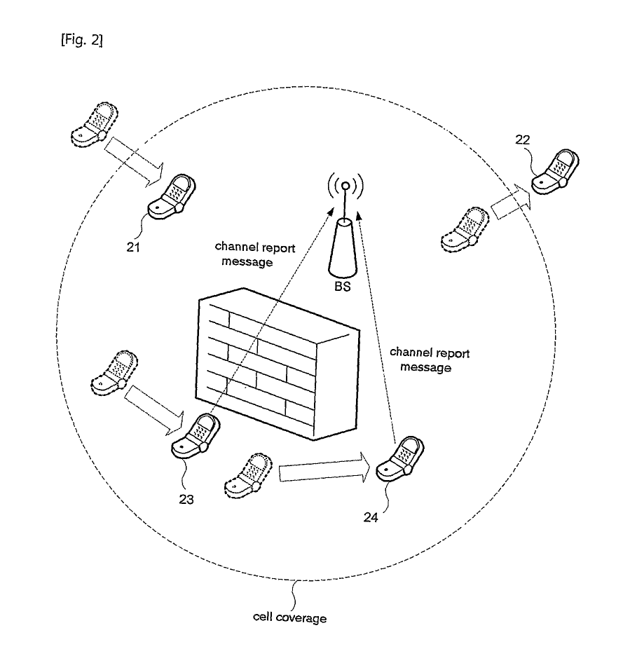

FIG. 2 is a diagram showing the channel environment of a next generation cellular communication system.

The next generation cellular communication system of the present invention includes a base station BS and a plurality of terminals 21, 22, 23 and 24 located inside a cell for which the base station BS is responsible. The base station BS assigns low frequency band control channel slots to terminals located in the cell for which the base station BS is responsible for. The terminals include a terminal 21 that newly enters the cell, a terminal 22 that exits the cell, a terminal 23 the channel environment of which changes from a line-of-sight channel environment to a non-line-of-sight channel environment, and a terminal 24 the channel environment of which changes from a non-line-of-sight channel environment to a line-of-sight channel environment.

The base station BS newly assigns a control channel slot to the terminal 21 that enters the cell, and the terminal 22 that exits the cell of the corresponding base station BS returns its assigned control channel slot to the base station BS. The terminals 23 and 24 located inside the cell periodically transmit channel report messages to the base station BS. The control channel slot corresponds to the low frequency band. The base station and the terminal can communicate with each other using a control channel slot even in a non-line-of-sight channel environment.

Furthermore, as a terminal located inside the cell for which the base station BS is responsible moves across the cell, the channel environment of the terminal changes from a line-of-sight channel environment to a non-line-of-sight channel environment, or from a non-line-of-sight channel environment to a line-of-sight channel environment. When the channel environment changes from a line-of-sight channel environment to a non-line-of-sight channel environment or from a non-line-of-sight channel environment to a line-of-sight channel environment, the terminal transmits a channel report message to the base station. This channel report message includes the Identification (ID), location, speed (mobility) and channel state (line-of-sight channel/non-line-of-sight channel) of the terminal.

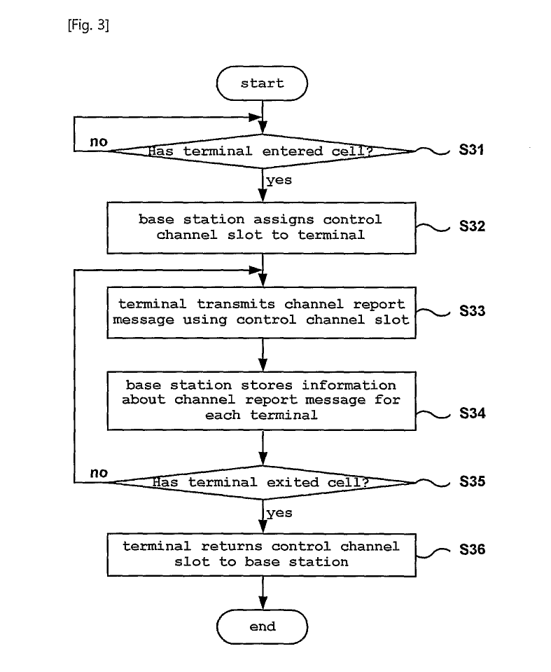

FIG. 3 is a flowchart showing a process in which a base station assigns a low frequency band control channel slot to a terminal that enters a cell and a terminal that exits the cell returns the control channel slot to the base station.

When the terminal enters the cell at step S31, the base station responsible for the cell assigns a control channel slot of the remaining control channel resources to the corresponding terminal at step S32. While staying in the cell, the terminal creates a channel report message and transmits the channel report message to the base station using the control channel slot assigned thereto at step S33. Meanwhile, the base station stores information about the channel report message for each terminal at step S34. When the corresponding terminal exits the cell at step S35, the terminal returns the corresponding control channel slot to the base station responsible for the cell at step S36.

The terminal may periodically transmit a channel report message, or transmit a channel report message when the channel environment changes from a line-of-sight channel environment to a non-line-of-sight channel environment or from a non-line-of-sight channel environment to a line-of-sight channel environment. The terminal may determine whether the channel environment has been changed from a line-of-sight channel environment to a non-line-of-sight channel environment or the terminal has moved from the border of the cell using the location information thereof and a change in the intensity of a received signal. That is, if the intensity of a received signal is abruptly reduced in the center portion of a cell, the terminal becomes aware that the channel environment thereof has been changed from a line-of-sight channel environment to a non-line-of-sight channel environment, creates a channel report message, and transmits the channel report message to the base station. Meanwhile, if the intensity of a received signal is gradually reduced in the peripheral portion of the cell, the terminal becomes aware that the terminal has exited the cell, and returns a control channel slot to the base station.

The base station receives the channel report message, including the ID, location, mobility and channel state of the terminal, from the terminal using a low frequency band control channel slot, as shown in FIG. 3. Accordingly, the base station can immediately become aware that the channel environment of the terminal has been changed from a line-of-sight channel environment to a non-line-of-sight channel, cut off the resources of the high frequency band assigned to the corresponding terminal immediately after becoming aware of the fact, establish a relay channel, and perform communication using the relay channel. Furthermore, the base station can immediately become aware that the channel environment of the terminal has been changed from a non-line-of-sight channel environment to a line-of-sight channel environment, assign the resources of a high frequency band to the corresponding terminal immediately after becoming aware of the fact, and rapidly provide a communication service.

The next generation cellular communication system that is taken into account in the present invention uses a high frequency band. Taking into consideration the propagation characteristics of high frequency signals and the capacity of a backbone network connecting base stations, the size of a cell is reduced to several tens of m, with the result that it is expected that the number of terminals that can stay in the cell is small. Furthermore, since the terminal transmits only a small-size channel report message to the base station via a control channel slot, the base station can divide control channel resources assigned thereto and assign control channel slots to all terminals within the cell.

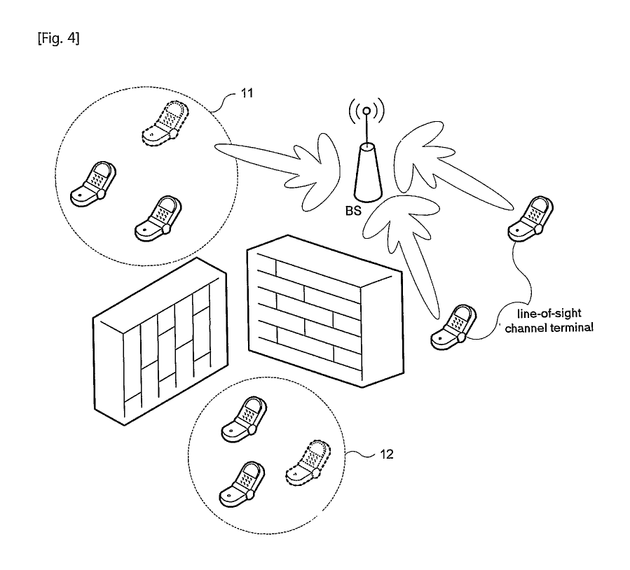

FIG. 4 is a diagram illustrating a problem that occurs when a base station establishes a relay channel. As described in conjunction with the problem of the method of constructing a communication link disclosed in Korean Patent No. 2007-100764, for a base station to establish a relay channel for enabling group collaboration and relay, a line-of-sight channel must be ensured between the relay-cooperation relay group 11 and the transmission/reception terminal group 12. Using the channel report message, the base station BS can detect a line-of-sight/non-line-of-sight channel between the base station and each terminal, but cannot detect a line-of-sight channel/non-line-of-sight channel between terminals. Accordingly, if a line-of-sight channel cannot be ensured between the relay-cooperation relay group 11 and the transmission/reception terminal group 12 as shown in FIG. 4 when the base station establishes a relay channel so as to communicate with a non-line-of-sight channel terminal, it is impossible to perform communication via the corresponding relay channel, with the result that it is impossible to perform communication between the corresponding base station and the non-line-of-sight channel terminal.

The present invention proposes a method in which the base station determines whether there is a line-of-sight channel between a non-line-of-sight channel terminal and a terminal adjacent to the non-line-of-sight channel terminal, so that a relay channel terminal that ensures a line-of-sight channel to the base station and ensures a line-of-sight channel to a non-line-of-sight channel terminal is searched for, and then a relay channel is established using the relay channel terminal.

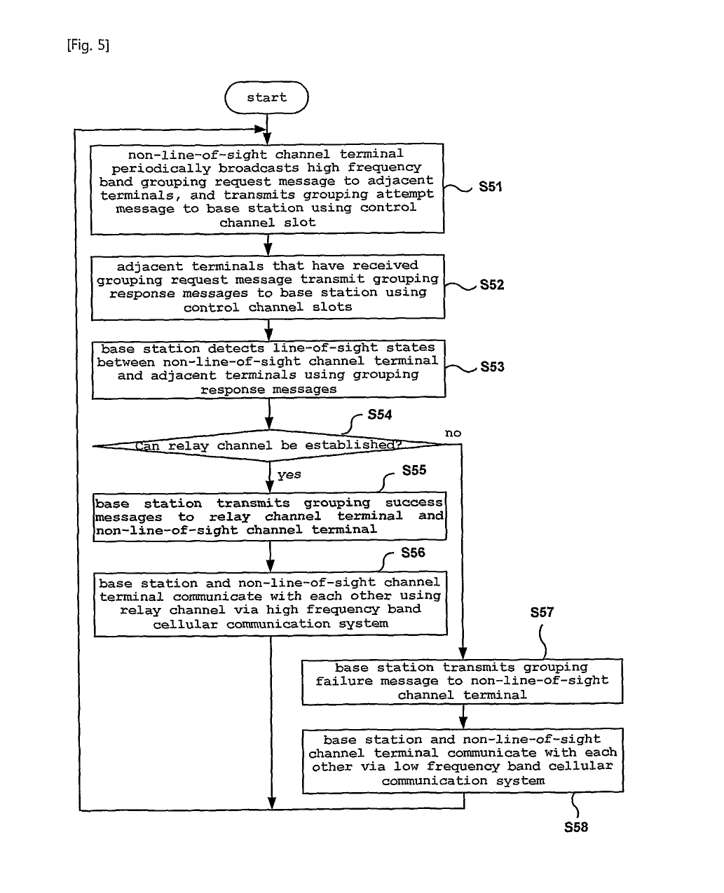

FIG. 5 is a flowchart showing a method of establishing a relay channel and communicating between a base station and a non-line-of-sight channel terminal according to a first embodiment of the present invention.

When the channel environment of the terminal changes from a line-of-sight channel environment to a non-line-of-sight channel environment, the terminal transmits a channel report message to the base station using a control channel slot, as shown in FIG. 3.

The non-line-of-sight channel terminal periodically broadcasts a grouping request message in a high frequency band to adjacent terminals, and provides notification of the transmission of the grouping request message to the base station by transmitting a grouping attempt message to the base station using a control channel slot at step S51. The grouping request message includes the ID of the non-line-of-sight channel terminal and transmission time. Since the grouping request message is broadcast in a high frequency band, only some of the terminals that are adjacent to the non-line-of-sight channel terminal and that can ensure line-of-sight channels to the non-line-of-sight channel terminal can receive the grouping request message. In this case, it is necessary to avoid interference with other terminals while taking into account the advantage of the easy reuse of frequencies from the point of view of the propagation characteristics of a high frequency band and the scheduling of the uplink and downlink of the adjacent terminals.

The adjacent terminals that have received the grouping request message from the non-line-of-sight channel terminal transmit grouping response messages to the base station using control channel slots assigned thereto at step S52. As described above, since the grouping request messages are broadcast in a high frequency band, only the non-line-of-sight channel terminal and the adjacent terminals ensuring line-of-sight channels can receive the grouping request message and transmit grouping response messages to the base station. Each of the grouping response messages transmitted by the adjacent terminals includes the ID of the non-line-of-sight channel terminal and transmission time included in the grouping request message, and further includes its own ID, the received signal-to-noise ratio (SNR) of the grouping request message, information about the presence of a line-of-sight/non-line-of-sight channel between the base station and itself, and its location and mobility.

After receiving the grouping attempt message from the non-line-of-sight channel terminal, the base station detects the presence of line-of-sight channels and link states between the non-line-of-sight channel terminal and the adjacent terminals using the grouping response messages received in a predetermined period at step S53, and determines whether a relay channel can be established between the base station and the non-line-of-sight channel terminal at step S54. That is, it is determined whether there is a relay channel terminal that ensures line-of-sight channels both to the base station and to the non-line-of-sight channel terminal and that does not communicate directly with the base station.

If a relay channel can be established at step S54, that is, if mutual line-of-sight channels can be ensured between the base station and the non-line-of-sight channel terminal and there is one or more relay channel terminals that do not communicate directly with the base station, the base station transmits grouping success messages to the respective relay channel terminals and the non-line-of-sight channel terminal using the control channel slots of the terminals at step S55. The base station and the non-line-of-sight channel terminal communicate with each other using the relay channel via the high frequency band cellular communication system at step S56.

Meanwhile, if the relay channel cannot be established at step S54, that is, if there is no relay channel terminal between the base station and the non-line-of-sight channel terminal, the base station transmits a grouping failure message to the non-line-of-sight channel terminal at step S57, and the base station and the non-line-of-sight channel terminal access a low frequency band cellular communication system and communicate with each other via the low frequency band cellular communication system at step S58.

When a channel environment is a non-line-of-sight channel environment, the non-line-of-sight channel terminal periodically broadcasts a grouping request message. The period of the transmission of the grouping request message may be variously set depending on the speed of movement of the non-line-of-sight channel terminal. That is, when the non-line-of-sight channel terminal moves fast, the grouping request message is broadcast every several tens of seconds. In contrast, when the non-line-of-sight channel terminal moves slowly, the grouping request message is broadcast every several minutes.

In the above-described method of establishing a relay channel and communicating between a base station and a non-line-of-sight channel terminal according to the first embodiment of the present invention, when the channel environment of a terminal changes from a line-of-sight channel environment to a non-line-of-sight channel environment, a relay channel capable of ensuring a line-of-sight channel to the base station and the non-line-of-sight channel terminal can be established and then high frequency band communication can be performed using the established relay channel. However, even in the case where the base station cannot establish a relay channel, the non-line-of-sight channel terminal must wait until it receives a grouping failure message from the base station, and access a low frequency band cellular communication system and perform a procedure for communication after receiving the grouping failure message.

For the non-line-of-sight channel terminal to receive a seamless communication service from the base station, in the case where there are one or more relay channel terminals, a relay channel capable of ensuring line-of-sight channels is established as soon as possible and then high frequency band communication is performed via the relay channel, and in the case where there is no relay channel terminal, the low frequency band cellular communication system must be accessed as soon as possible.

However, according to the first embodiment, the non-line-of-sight channel terminal cannot previously know the fact that a relay channel cannot be established, and there is the risk of disconnection of communication because a grouping failure message is received from the base station and then the low frequency band cellular communication system is accessed.

In a second embodiment of the present invention, a non-line-of-sight channel terminal transmits a grouping request message, intercepts one or more grouping response messages transmitted by one or more adjacent terminals to a base station, and determines whether there are one or more relay channel terminals by analyzing the analyzed grouping response messages. If it is determined that there is no relay channel terminal, the non-line-of-sight channel terminal waits until the base station transmits a grouping success message, and communicates via the high frequency band cellular communication system using a relay channel when a grouping success message is received. Meanwhile, if it is determined that there is no relay channel terminal, the non-line-of-sight channel terminal immediately prepares for low frequency band cellular communication.

According to the second embodiment of the present invention, in the case where a relay channel cannot be established, a non-line-of-sight channel terminal prepares for low frequency band cellular communication before receiving a grouping failure message from a base station, so that communication between the base station and the non-line-of-sight channel terminal can be performed seamlessly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of communicating between a base station and a non-line-of-sight channel terminal in a next generation cellular communication system, the method comprising:
a first step of the base station receiving channel state information from the non-line-of-sight channel terminal;
a second step of the base station collecting channel state information between the non-line-of-sight channel terminal and one or more terminals adjacent to the non-line-of-sight channel terminal;
a third step of, if there is a relay channel terminal that belongs to the adjacent terminals and that can ensure a line-of-sight channel to the base station and a line-of-sight channel to the non-line-of-sight channel terminal, the base station and the non-line-of-sight channel terminal performing cellular communication in a high frequency band via the relay channel terminal; and
a fourth step of, if there is no relay channel terminal that belongs to the adjacent terminals, the base station and the non-line-of-sight channel terminal performing cellular communication in a low frequency band.

2. The method as set forth in claim 1, wherein the first step is configured such that the base station assigns a low frequency band control channel slot to the non-line-of-sight channel terminal and the non-line-of-sight channel terminal transmits the channel state information to the base station using the control channel slot periodically or when a channel state changes.

3. The method as set forth in claim 1, wherein the second step is configured such that the non-line-of-sight channel terminal broadcasts a grouping request message in a high frequency band, and a terminal that is located within a cell and has received the grouping request message transmits a grouping response message to the base station in response to the grouping request message.

4. The method as set forth in claim 3, wherein the grouping request message includes an Identification (ID) information of the non-line-of-sight channel terminal and transmission time information of the grouping request message, and the grouping response message includes the ID of the non-line-of-sight channel terminal, the transmission time of the grouping request message, an ID of the grouping request message receiving terminal, and channel state information between the grouping request message receiving terminal and the base station.

5. The method as set forth in claim 3, wherein the grouping response message is transmitted using the low frequency band control channel slot.

6. The method as set forth in claim 1, wherein the third step is configured such that, if there is a relay channel terminal that belongs to the adjacent terminals, the base station transmits grouping success messages to the relay channel terminal and the non-line-of-sight channel terminal.

7. The method as set forth in claim 1, wherein the fourth step is configured such that, if there is no relay channel terminal that belongs to the adjacent terminals, the base station transmits a grouping failure message to the non-line-of-sight channel terminal.

8. The method as set forth in claim 3, wherein the fourth step is configured such that the non-line-of-sight channel terminal intercepts the grouping response message and prepares for the low frequency band cellular communication if it is determined that there is no relay channel terminal.

9. The method as set forth in claim 3, wherein the non-line-of-sight channel terminal periodically broadcasts the grouping request message.

10. The method as set forth in claim 9, wherein a period of broadcasting of the grouping request message varies depending on mobility of the non-line-of-sight channel terminal.

11. A method of establishing a relay channel between a base station and a non-line-of-sight channel terminal in a next generation cellular communication system, the method comprising:
a first step of the base station receiving channel state information from the non-line-of-sight channel terminal;
a second step of the base station collecting channel state information between the non-line-of-sight channel terminal and one or more terminals adjacent to the non-line-of-sight channel terminal; and
a third step of, if there is a relay channel terminal that belongs to the adjacent terminals and that can ensure a line-of-sight channel to the base station and a line-of-sight channel to the non-line-of-sight channel terminal, establishing a relay channel, including the relay channel terminal, between the base station and the non-line-of-sight channel terminal.

12. The method as set forth in claim 11, wherein the first step is configured such that the base station assigns a low frequency band control channel slot to the non-line-of-sight channel terminal and the non-line-of-sight channel terminal transmits the channel state information to the base station using the control channel slot periodically or when a channel state changes.

13. The method as set forth in claim 11, wherein the second step is configured such that the non-line-of-sight channel terminal broadcasts a grouping request message in a high frequency band, and a terminal that is located within a cell and has received the grouping request message transmits a grouping response message to the base station in response to the grouping request message.

14. The method as set forth in claim 13, wherein the grouping request message includes an Identification (ID) information of the non-line-of-sight channel terminal and transmission time information of the grouping request message, and the grouping response message includes the ID of the non-line-of-sight channel terminal, the transmission time of the grouping request message, an ID of the grouping request message receiving terminal, and channel state information between the grouping request message receiving terminal and the base station.

15. The method as set forth in claim 13, wherein the grouping response message is transmitted using the low frequency band control channel slot.

16. The method as set forth in claim 11, wherein the third step is configured such that, if there is a relay channel terminal that belongs to the adjacent terminals, the base station transmits grouping success messages to the relay channel terminal and the non-line-of-sight channel terminal.

17. The method as set forth in claim 13, wherein the non-line-of-sight channel terminal periodically broadcasts the grouping request message.

18. The method as set forth in claim 17, wherein a period of broadcasting of the grouping request message varies depending on mobility of the non-line-of-sight channel terminal.
